(19) United States
(12) Patent Application Publication
(10) Pub. No.: US 2007/0166217 A1
(43) Pub. Date: Jul. 19, 2007

(54) Method for producing strong base phosphates

(76) Inventor: Mohamed Takhim, Louvain-la-Neuve (BE)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 10/583,735

(22) PCT Filed: Dec. 23, 2004
(86) PCT No.: PCT/EP04/53695

§ 371 Date: Aug. 4, 2006

(30) Foreign Application Priority Data
Dec. 24, 2003 (BE) 2003/0682

(51) Int. Cl. C01B 25/32

(52) U.S. Cl. 423/305

(57) ABSTRACT

The inventive method for producing strong base phosphates consists in forming a pulp consisting of an aqueous phase which contains a water-soluble calcium phosphate and a solid impurity-containing phase, in separating said phases, transferring calcium ions to a liquid phase by a strong base ions associated with forming the aqueous solution of the pure phosphate(s) of said strong base and in precipitating a pure water-insoluble calcium phosphate. Said method also consists in mixing phosphoric ores and acid in such a way that a pasty triple superphosphate composition is obtained and in adding water thereto in order to produce said pulp.

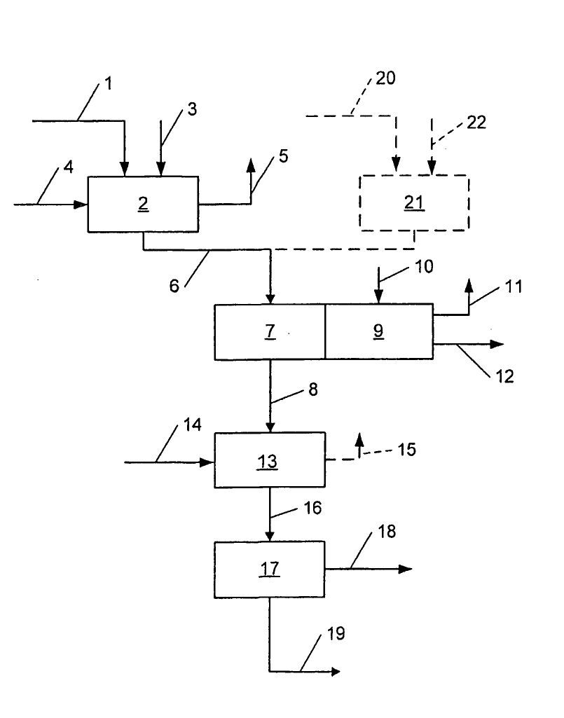

The present invention relates to the preparation of strong base phosphates.

The preparation of strong base phosphates by reacting purified phosphoric acid with said strong bases is known in general.

Within the context of the present invention, the term “strong bases” will be understood to mean a base which is capable of increasing the pH in a calcium dihydrogen phosphate (MCP) medium in aqueous solution, for example the oxide, hydroxide or water-soluble salts of sodium, potassium or ammonium.

Also known is a method for preparing strong base phosphates, comprising:
forming a pulp consisting of an aqueous phase, which contains water-soluble calcium phosphate in the form of calcium ions and phosphate ions, and a solid phase which contains impurities,
separating said liquid phase and said solid phase,
in the liquid phase resulting from said separation, displacing the calcium ions by ions of a strong base which results in formation of an aqueous solution of phosphate(s) of said strong base and precipitation of a water-insoluble calcium phosphate, and
isolating the precipitated calcium phosphate from the aqueous solution of strong base phosphate(s)
   (see DE-A-1667575). This method requires ore etching using an excess of concentrated phosphoric acid under conditions for crystallizing the calcium dihydrogen phosphate (MCP) and dissolving the impurities in the liquid phase, then redissolving the MCP crystals, which makes it a complex and expensive method.

Also known are methods for producing pure phosphoric acid by etching the ore using phosphoric acid (see, for example, FR-A-2343696, U.S. Pat. No. 3,323,864, FR-A-1082404 and EP-A-0087323). Following this etching and an optional solid/liquid separation, these methods involve precipitating a calcium salt by way of an acid, in order to obtain phosphoric acid of good quality. In some of these methods, the precipitated calcium salt still contains original impurities from the ore, and in others use is made of hydrochloric acid, hydrofluoric acid or fluosilicic acid, which are expensive acids that are dangerous to handle.

Also known is a method for producing phosphoric acid by etching ore using phosphoric acid (see WO-A-02/12120). In this method, the calcium phosphate solution obtained from the solid/liquid separation of the pulp resulting from the phosphoric etching step is treated with hydrochloric acid so as to isolate, on the one hand, an aqueous solution of calcium chloride and, on the other hand, pure phosphoric acid.

The object of the present invention is to produce strong phosphate bases of higher quality in a simple, effective and inexpensive manner.

In order to solve these problems, the invention provides a method as indicated above, in which the step of forming said pulp comprises
mixing phosphate ore and phosphoric acid for etching, in order to obtain a pasty triple superphosphate (TSP) composition, and
adding water to the TSP composition obtained.

This method therefore starts from phosphate-containing products with little added value. Among the phosphate-containing products with little added value, mention may be made of phosphate ore and the products resulting from a simple etching of this ore with for example a crude phosphoric acid, such as the aforementioned pasty composition or the product of drying the latter, which is used in particular as a fertilizer. All these products generally still contain the impurities which are present not only in the ore but also in the crude etching acid, which explains the fact that they are limited to being used as fertilizers. Given the simple treatment to which the raw materials have been subjected in order for them to be obtained, these products are also relatively inexpensive.

In order to obtain the aforementioned pulp, it is therefore possible to carry out a customary process of etching the phosphate ore with phosphoric acid. For example, such a phosphoric etching method is known for producing phosphate-based fertilizers. The etching product is left to cure and then simply to dry. Following optional granulation, it is used in the form of a non-purified calcium phosphate, that is to say a calcium phosphate that has not been freed of the impurities from the ore and the crude phosphoric acid used for etching. This fertilizer, which mainly consists of calcium triple superphosphate (TSP), is also known as straight fertilizer.

Such a method for preparing TSP is described for example in Wesenberg, Manufacturing Concentrated Superphosphate, in Manual of Fertilizer Processing, Marcel Drekker Inc., pages 488-514, 1987.

The pulp according to the invention is then obtained by dissolving the aforementioned pasty composition in water immediately after it has been formed. It is also possible to use dried and optionally granulated TSP, and to dissolve it in water so as to obtain a suitable pulp.

In the forming step of the method according to the invention, the pulp advantageously has a pH of 1.2 to 3.2, preferably 2 to 3, in particular 2.5, and the molar ratio Ca/P is advantageously kept at a value of around 0.4 to 0.6, preferably 0.45. At this high pH, and preferably at ambient pressure and temperature, the impurities formed in particular of Fe, Si, U, Cd, As, F, etc. are only slightly dissolved, whereas the Ca⁺⁺ ion, the content of which in the pulp is relatively high (up to 16% by weight), is in solution. This is because the calcium phosphate that has formed is in a water-soluble form, in particular in the form of calcium dihydrogen phosphate (MCP).

The step of solid/liquid separation may be carried out by any appropriate known means, for example by filtration, decantation or else as described in WO-A-02/12120. The aforementioned displacement can thus be carried out in a very clean liquid phase which is as free of impurities as possible.

During the step of displacement by a strong base, a rapid rise in pH can clearly be observed. This introduction of a strong base to the solution of calcium dihydrogen phosphate (MCP) results on the one hand in a displacement of the Ca⁺⁺ ions by ions of the strong base which is used and thus in the formation of the phosphate of the strong base, which is very pure and soluble in water, and on the other hand in the simultaneous precipitation of pure calcium monohydrogen phosphate (DCP).

The amount of strong base added for the displacement is determined by the product that it is desired to obtain. For example, it is advantageously possible to add Na₂CO₃ and/or NaOH to the liquid phase resulting from said separation, so as to obtain a molar ratio Na/P which is approximately around 1 to 3, preferably around 1.67, in order to obtain STPP. In this case, in the isolated aqueous solution, after the precipitation of the DCP, a molar ratio between sodium monohydrogen phosphate and sodium dihydrogen phosphate of around 2/1 is obtained.

The isolation of the two phases that have formed is carried out in any manner known per se, for example by decantation, filtration or a similar process.

The aqueous solutions of strong bases can then be treated in a known manner to form powders, tablets or concentrated solutions of monophosphates, diphosphates or polyphosphates of sodium, potassium or ammonium, and in particular sodium tripolyphosphate (STPP). These phosphates are of technical grade and can be used inter alia in the field of detergents, the treatment of metal surfaces and the formulation of liquid fertilizer for example.

The pure DCP obtained is a product which can be used for example in animal feeds.

Other advantageous embodiments of the method according to the invention are given in the appended claims.

The invention will now be described in more detail with the aid of non-limiting examples of embodiments.

### EXAMPLE 1

An embodiment of the invention in an installation as shown in the single appended figure can be conceived.

A phosphate ore (100 g) is fed at 1 into a reactor 2 in which an etching liquid which contains phosphate ions is introduced at 4, for example crude H₃PO₄ (190 g) (also known as WPPA).

The phosphate ore is preferably ground and it advantageously has a P₂O₅ content of around 28-30% by weight, whereas the crude phosphoric acid has a P₂O₅ content of around 30-40% by weight.

The digestion conditions are set so as to prevent any precipitation of calcium phosphate.

Digestion is advantageously carried out at ambient pressure and temperature. A higher temperature can of course be provided, ranging up to 80° C. for example.

Following the formation of a pasty composition with a P₂O₅ content of 30-35% by weight, water (190 g) is gradually introduced into the reactor 2, at 3.

A conduit 5 permits the removal of CO₂ gas (5 g) at the top of the reactor.

Following digestion in the first reactor 2, the pulp that has formed is transferred via the conduit 6 to a decantation/filtration device 7 in which separation takes place between a liquid phase (380 g), which is removed via the conduit 8, and a solid phase which, in the washing device 9, is washed with water (190 g) introduced at 10.

In the decantation/filtration device 7, the pH is in particular 2-3. At this high pH, most of the metals forming the impurities precipitate, with the exception of calcium which remains in aqueous solution in the form of calcium dihydrogen phosphate (MCP). The water (190 g) used to wash the filter cake is removed from the washing device 9 via the conduit 11, and can optionally be recycled to the water supplied to the reactor 2 at 3. The impurities (100 g) are removed at 12 in the form of a solid concentrate.

The MCP solution (380 g) is transferred via the conduit 8 to a precipitation device 13, into which a strong base (47 g) is introduced at 14, for example sodium carbonate Na₂CO₃.

The sudden increase in pH, to a value of 4.5 to 7, preferably 5 to 6.5, advantageously 6, has the effect of precipitating water-insoluble calcium monohydrogen phosphate (DCP), releasing CO₂ (19 g) at 15, and displacing the Ca++ ions by Na+ ions in the aqueous solution. The suspension obtained is led through the conduit 16 to a filtration device 17. A filter cake formed of DCP (150 g) is removed at 18, and the filtrate obtained at 19 (258 g) contains pure Na phosphates in solution, for example in a molar ratio Na₂HPO₄/NaH2PO₄ of 2/1. This solution has a molar ratio Na/P of 5/3 (Na/P=1.67)

Instead of using a pulp resulting from phosphoric etching of phosphate ore, it is also possible to dilute a commercially available straight fertilizer (TSP) in water. To this end, this fertilizer is introduced at 20 into a vessel 21, to which water is added at 22. The conditions are set such that the TSP dissolves while the impurities usually contained therein remain in the form of solid particles in suspension. This suspension can then be fed to the decantation/filtration device 7 and can undergo the same treatment as that described above.

It should be understood that the present invention is in no way limited to the embodiments described above, and that it can be modified within the scope of the appended claims.

1. Method for preparing strong base phosphates, comprising:
forming a pulp consisting of an aqueous phase, which contains water-soluble calcium phosphate in the form of calcium ions and phosphate ions, and a solid phase which contains impurities,
separating said liquid phase and said solid phase,
in the liquid phase resulting from said separation, displacing the calcium ions by ions of a strong base which results in formation of an aqueous solution of phosphate(s) of said strong base and precipitation of a water-insoluble calcium phosphate, and
isolating the precipitated calcium phosphate from the aqueous solution of strong base phosphate(s),
wherein the step of forming said pulp comprises
mixing phosphate ore and phosphoric acid for etching, in order to obtain a pasty triple superphosphate (TSP) composition, and
adding water to the TSP composition obtained.

2. Method according to claim 1, wherein said forming step comprises drying the TSP composition and optionally storing it, between the aforementioned mixing step and the water addition step.

3. Method according to claim 2, wherein the phosphoric acid for etching has a P₂O₅ content of between 30% and 50% by weight, preferably between 35 and 40% by weight.

4. Method according to claim 3, wherein the pulp of the forming step has a pH of 1.2 to 3.2, preferably 2 to 3, advantageously 2.5.

5. Method according to claim 4, wherein said pulp, the molar ratio Ca/P is around 0.4 to 0.6.

6. Method according to claim 5, wherein it takes place at ambient pressure and temperature.

7. Method according to claim 6, wherein said strong base ions are sodium ions, potassium ions and/or ammonium ions.

8. Method according to claim 7, wherein the water-soluble phosphate is in the form of calcium dihydrogen phosphate (MCP), and in that the water-insoluble calcium phosphate is in the form of calcium monohydrogen phosphate (DCP).

9. Method according to claim 8 wherein during the displacement in the liquid phase resulting from said separation, said liquid phase has a pH of 4.5 to 7.

10. Method according to claim 9 wherein in order to obtain said displacement, Na₂CO₃ and/or NaOH is added to the liquid phase resulting from said separation, in a quantity such that the molar ratio Na/P is around 1 to 3.

11. Method according to claim 10, wherein the aqueous solution of strong base has a molar ratio between sodium monohydrogen phosphate and sodium dihydrogen phosphate of around 2/1.

12. Method according to claim 11, wherein the phosphoric acid for etching is phosphoric acid known as WPPA.

13. Method according to claim 4, wherein said pH is 2 to 3.

14. Method according to claim 13, wherein said pH is 2.5.

15. Method according to claim 5, wherein the molar ratio is 0.45.

16. Method according to claim 9, wherein said pH is 5 to 6.5.

17. Method according to claim 16, wherein said pH is 6.

18. Method according to claim 10, wherein said molar ratio is about 1.67.
